(19) United States
(12) Patent Application Publication
(10) Pub. No.: US 2009/0267337 A1
(43) Pub. Date: Oct. 29, 2009

(54) MOTOR VEHICLE FRAME

(75) Inventors: Rolf Siekaup, Paderborn (DE); Klaus Keuter, Delbrueck (DE); Wolfram Linnig, Paderborn (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Benteler Automobiltechnik GmbH, Paderborn (DE)

(21) Appl. No.: 12/429,274

(22) Filed: Apr. 24, 2009

(30) Foreign Application Priority Data
Apr. 24, 2008 (DE) 10 2008 020 694.6

(51) Int. Cl. B62D 21/00

(52) U.S. Cl. 280/781

(57) ABSTRACT

A vehicle frame for a motor vehicle, configured as ladder frame, includes two side rails which are connected by cross members. Each side rail is made of at least one longitudinally welded hollow section, wherein the hollow section has a cross section in the shape of a rectangle with wall portions, which are curved in cross section, and rounded longitude edges. The hollow section may hereby be roll-formed. The cross section of the side rails varies in its length dimension and ascends starting from a front region to a maximum and descends thereafter to a rear region H. The rounded cross sectional configuration of the side rails with slight oversizing of the outer dimensions results in a greater geometrical moment of inertia. As a result, the wall thickness can be reduced so as to attain a decrease in weight and cost savings.

### CROSS-REFERENCES TO RELATED APPLICATIONS

This application claims the priority of German Patent Application, Serial No. 10 2008 020 694.6, filed Apr. 24, 2008, pursuant to 35 U.S.C. 119(a)-(d), the content of which is incorporated herein by reference in its entirety as if fully set forth herein.

### BACKGROUND OF THE INVENTION

The present invention relates to a vehicle frame for a motor vehicle, configured as ladder frame with two side rails which are connected by cross members.

The following discussion of related art is provided to assist the reader in understanding the advantages of the invention, and is not to be construed as an admission that this related art is prior art to this invention.

Modern automobile construction use ladder-type frame structures, so-called ladder frames, which form the basis for the constructive design of the bodies for light and heavy utility vehicles as well as for off-road vehicles or small trucks. A ladder frame typically includes longitudinal side rails which are connected to one another by cross members. The ladder frame forms the platform for assembly of various vehicle components, such as body, motor, suspension system, axle attachment, etc. The side rails can be constructed essentially in three different ways. The side rails can be designed as C-shaped sections which are open toward the frame interior, or manufactured in the shape of a shell construction, or designed as hydro-formed hollow sections.

German Offenlegungsschrift DE 100 42 618 A1 discloses a conventional ladder frame which includes a pair of side rails, each comprised of three separate parts, namely a front part with closed hollow cross section, a central part with open cross section, and a rear part with closed hollow cross section. The parts with closed hollow cross section have a rectangular cross sectional configuration, whereas the components with open cross section have a C-shaped cross section.

In particular when off-road vehicles and small trucks (pickups) are involved, the trend goes in the direction of closed sections because torsional and vertical rigidity of the body can be improved. Purely open sections are predominantly used in truck construction to render possible a wide variety.

It would be desirable and advantageous to provide an improved vehicle frame which obviates prior art shortcomings and which is simple and cost-efficient in structure and yet reliable in operation and exhibits a torsional rigidity which is optimized to withstand stress.

### SUMMARY OF THE INVENTION

The present invention resolves prior art problems by disclosing two approaches which are technically interrelated and use as side rails longitudinally welded hollow sections with round or rounded cross section. The rounded torsion and bending structures of the side rails with slight oversizing of the outer dimensions result in a greater geometrical moment of inertia. For that reason, the wall thickness of the side rail can be reduced. As a result, weight can be saved and the cost factor can be improved. At the same time, the available installation space is used in an optimum manner.

According to one aspect of the present invention, a vehicle frame for a motor vehicle, configured as ladder frame, includes two side rails, and plural cross members to connect the side rails, wherein each side rail has at least one length portion which extends between a front one of the cross members and a rear one of the cross members and is made of a longitudinally welded hollow section having a round cross section.

According to another aspect of the present invention, vehicle frame for a motor vehicle, configured as ladder frame, includes two side rails, and plural cross members to connect the side rails, wherein each side rail is made of at least one longitudinally welded hollow section having a cross section in the shape of a rectangle with wall portions, which are curved in cross section, and rounded longitude edges to connect the wall portions. This configuration enables the side rail to be sized to best conform to stress while utilizing available installation space in a best possible manner. In particular, it is possible to increase the geometrical moment of inertia so that a reduction in wall thickness and the thus accompanying reduction in weight can be realized.

According to another feature of the present invention, the hollow section can be roll-formed. As a result, production and cost benefits are realized when compared to shell and hydroforming solutions. Starting material for the manufacture of the hollow section is a sheet metal blank or a rolled metal sheet. This is cut to size in correspondence to the development of the hollow section, pre-formed, and subsequently rolled-in. Thereafter, the longitude edges are joined by welding. It is also possible to provide the side rail or the hollow profile with a varying wall thickness in its length dimension.

According to another feature of the present invention, the length portion of each side rail may have varying cross section. As a result, the side rail can be configured to best conform to stress through adjustment of the geometrical moment of inertia. In other words, the vehicle ladder frame according to the invention has optimum torsional rigidity.

According to another feature of the present invention, the cross section of each side rail may vary at a ratio of 1:1.5 to 1:2.5 in relation to a smallest cross sectional area with respect to a greatest cross sectional area.

According to another feature of the present invention, the cross section of each side rail may ascend from a front region to a maximum and descend to a rear region of the length portion.

According to another feature of the present invention, the longitude edges may be curved at a radius which is greater than or equal to 20 mm. At least two longitude edges may hereby define radii which differ from one another. This measure also contributes to optimization of the torsional rigidity of the side rails and the vehicle frame

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a perspective illustration of a vehicle frame according to the present invention;

FIG. 2 is a top view of the vehicle frame;

FIG. 3 is a side view of the vehicle frame;

FIG. 4 is a top view of a leading module of the vehicle frame;

FIG. 5 is a top view of a center module of the vehicle frame;

FIG. 6 is a top view of a trailing module of the vehicle frame;

FIG. 7 is a section through the vehicle frame of FIG. 2, taken along the line A-A;

FIG. 8 is a section through the vehicle frame of FIG. 2, taken along the line B-B;

FIG. 9 is a section through the vehicle frame of FIG. 2, taken along the line C-C;

FIG. 10 is a section through the vehicle frame of FIG. 2, taken along the line D-D;

FIG. 11 is a section through the vehicle frame of FIG. 2, taken along the line E-E;

FIG. 12 is a section through the vehicle frame of FIG. 2, taken along the line F-F;

FIG. 13 is a section through the vehicle frame of FIG. 2, taken along the line G-G; and

FIG. 14 is a cross section of a superimposed illustration of a cross sectional configuration of a side rail in accordance with the present invention and a cross sectional configuration of a conventional side rail.

### DETAILED DESCRIPTION OF PREFERRED EMBODIMENTS

Throughout all the Figures, same or corresponding elements may generally be indicated by same reference numerals. These depicted embodiments are to be understood as illustrative of the invention and not as limiting in any way. It should also be understood that the Figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

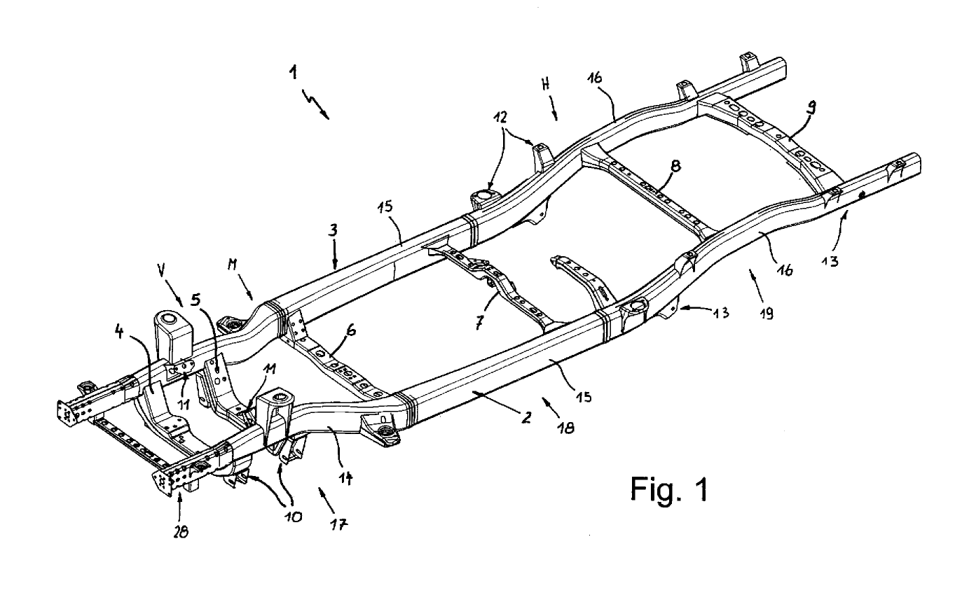

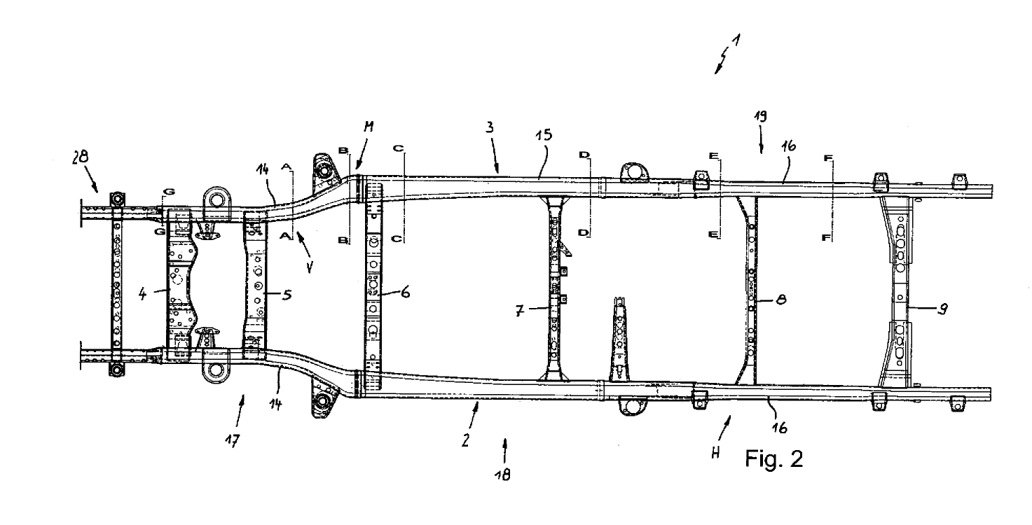

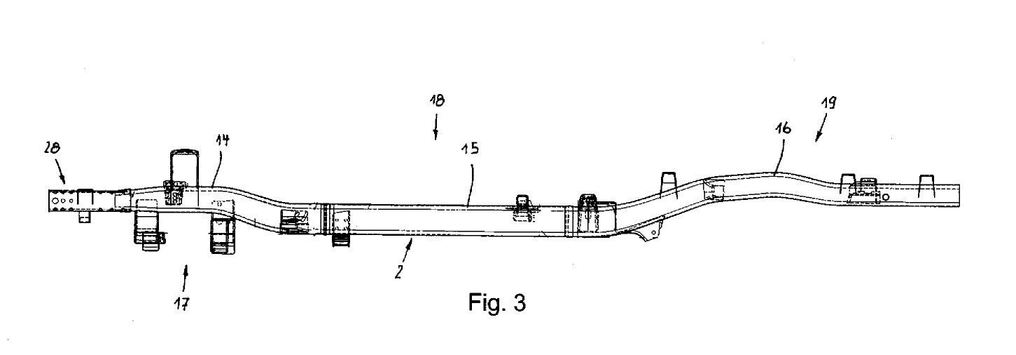

Turning now to the drawing, and in particular to FIG. 1, there is shown a perspective illustration of a vehicle frame according to the present invention, generally designated by reference numeral 1. This type of vehicle frame construction is also termed in the art as ladder frame.

The ladder frame 1 includes two side rails 2, 3 which are connected by cross members 4-9. The ladder frame 1 serves as platform for assembly of various vehicle components, such as body, motor, and also axle attachment. Reference numeral 10 designates in FIG. 1 a front-axle attachment. Reference numeral 11 designates a motor support and reference numeral 12 designates a cabin and loading area attachment. Reference numeral 13 designates a rear-axle attachment.

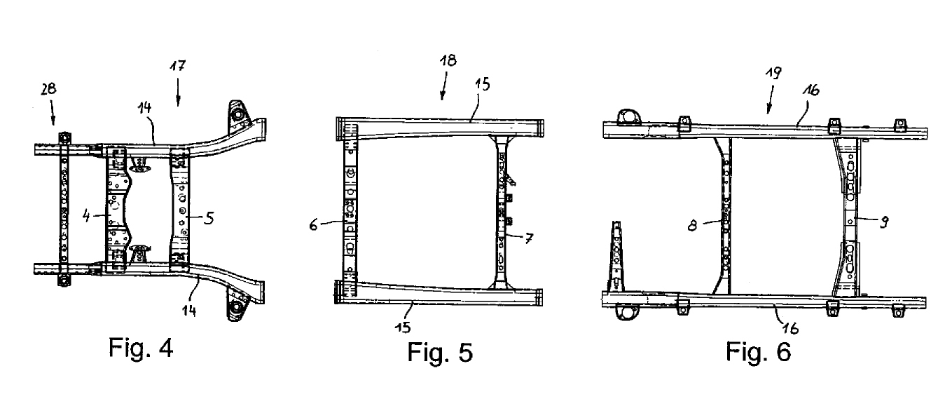

Each of the side rails 2, 3 includes a front hollow section 14, a central hollow section 15, and a rear hollow section 16. Left and right hollow sections 14, 15, 16 are respectively connected via cross members 4, 5; 6, 7 and 8, 9, respectively, and form a leading module 17, a center module 18 and a trailing module 19, as can be seen in FIGS. 4, 5, and 6. The modules 17, 18, 19 are plugged together and completed to form the ladder frame 1. The hollow sections 14, 15, 16 are hereby plugged into one another at their respective ends and joined. Disposed anteriorly of the leading module 17 is a front module 28 for attachment of the front bumper.

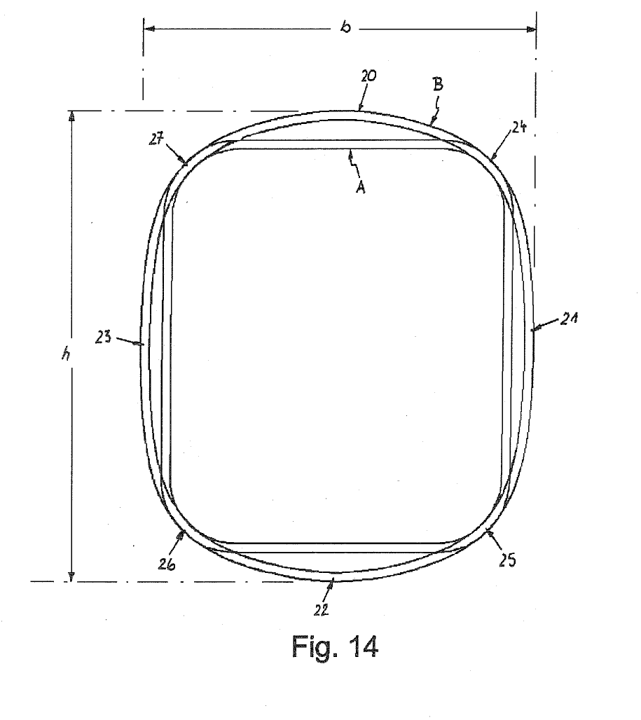

The hollow sections 14, 15, 16 are roll-formed from sheet metal blanks and longitudinally welded. Each hollow section 14, 15, 16 has a rounded cross section or a generally rectangular cross sectional configuration with wall portions 20-23, which are curved in cross section, and rounded longitude edges 24-27 (see FIG. 14).

As a result of this cross sectional configuration, the geometrical moment of inertia is increased in comparison with a rectangular cross sectional configuration having straight wall portions. A rectangular cross section with conventional straight wall portions is designated with A in FIG. 14. The rectangular rounded cross sectional configuration in accordance with the present invention is designated with B.

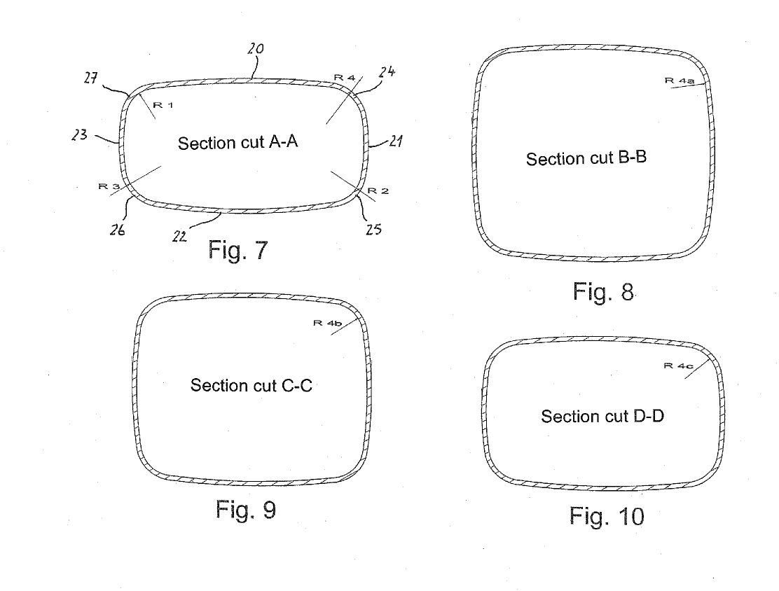

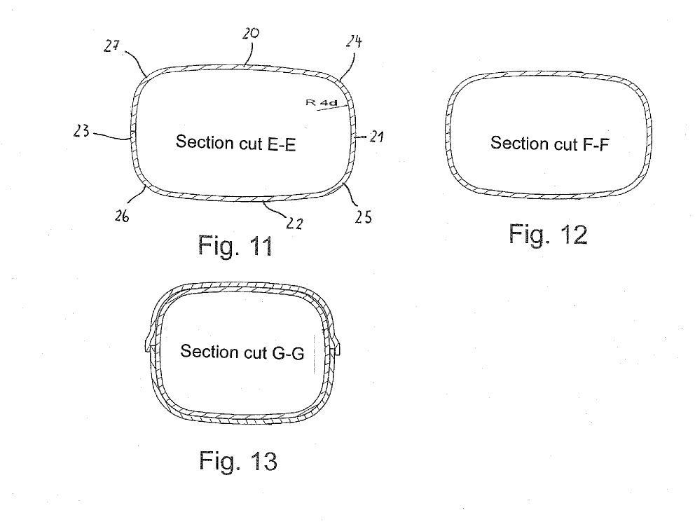

The cross section of the side rails 2, 3 varies in its length dimension. This is clearly shown in FIGS. 7-13 which illustrate various sectional views of the cross section of the side rails 2, 3. The basic cross sectional configuration is rectangular with curved wall portions 20-23 and rounded longitude edges 24-27, with the height h of the side rails 2, 3 exceeding the width b (see FIG. 14).

The cross section of the side rails 2, 3 ascends in its length dimension starting from a front region V (see FIGS. 1 and 7) up to a maximum M (see FIGS. 1 and 8). Section B-B (FIG. 8) shows that the maximum is reached at an end of the hollow section 14 at the transition to the hollow section 15. The cross section descends again toward a rear region H (see FIGS. 1 and 12). The cross section of the side rails 2, 3 varies during the course of the length dimension, in particular at a ratio of 1:1.5 to 1:2.5. The side rails 2, 3 have thus a cross sectional configuration which is suited to stress which the motor vehicle is expected to be exposed to. Tensions encountered during operational stress are reduced or diverted as a result of the cross sectional configuration and the variation of the cross sectional profile in length direction. The design of the side rails 2, 3 permits a reduction in wall thickness and thus savings of material and weight.

The radius R1-R4, R4a-d of the longitude edges 24-27 is greater than or equal to 20 mm. In particular, the radius R1-R4, R4a-d ranges between 21 mm and 25 mm. Also the radius R1-R4, R4a-d along the longitude edges 24-27 may vary along the length dimension of a side rail 2, 3. This becomes clear with reference to the radii R1-R4, R4a-d. The radius decreases along the portion between the section A-A and the section C-C from R4 to R4b. The radii R4b and R4c remain the same along the portion between section C-C and the section D-D. The radius then decreases again to R4d along the portion between the section D-D and the section E-E and then slightly tapers off again.

As can further be seen, especially with reference to FIG. 7, the radii R1 and R2 as well as R3 and R4 differ from one another along the longitude edges 24-27. The radii R1 and R2 are the same whereas the radius R3 is greater than the radii R1 and R2. The radius R4 is again greater than the radius R3. This, too, is a consequence of constructing the side rails 2, 3 to best conform to load, combined with the objective to optimize the torsional rigidity of the ladder frame 1 according to the invention.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A vehicle frame for a motor vehicle, configured as ladder frame, comprising:
two side rails; and
plural cross members to connect the side rails,
wherein each side rail has at least one length portion which extends between a front one of the cross members and a rear one of the cross members and is made of a longitudinally welded hollow section having a round cross section.

2. The vehicle frame of claim 1, wherein the hollow section is roll-formed.

3. The vehicle frame of claim 1, wherein the length portion of each side rail has varying cross section.

4. The vehicle frame of claim 3, wherein the cross section of each side rail varies at a ratio of 1:1.5 to 1:2.5.

5. The vehicle frame of claim 3, wherein the cross section of each side rail ascends from a front region to a maximum and descends to a rear region of the length portion.

6. A vehicle frame for a motor vehicle, configured as ladder frame, comprising:
two side rails; and
plural cross members to connect the side rails,
wherein each side rail is made of at least one longitudinally welded hollow section having a cross section in the shape of a rectangle with wall portions, which are curved in cross section, and rounded longitude edges to connect the wall portions.

7. The vehicle frame of claim 6, wherein the hollow section is roll-formed.

8. The vehicle frame of claim 6, wherein the length portion of each side rail has varying cross section.

9. The vehicle frame of claim 8, wherein the cross section of each side rail varies at a ratio of 1:1.5 to 1:2.5.

10. The vehicle frame of claim 8, wherein the cross section of each side rail ascends from a front region to a maximum and descends to a rear region of the length portion.

11. The vehicle frame of claim 6, wherein the longitude edges are curved at a radius which is greater than or equal to 20 mm.

12. The vehicle frame of claim 6, wherein at least two of the longitude edges have radii which differ from one another.
